(19) United States
(12) Patent Application Publication
(10) Pub. No.: US 2008/0016159 A1
(43) Pub. Date: Jan. 17, 2008

(54) Chargeable short message service (SMS) spam

(76) Inventor: Yigang Cai, Naperville, IL (US)

Correspondence Address: WERNER ULRICH, 434 MAPLE STREET, GLEN ELLYN, IL, 60137-3826, US

(21) Appl. No.: 11/485,817

(22) Filed: Jul. 13, 2006

(51) Int. Cl. G06F 15/16

(52) U.S. Cl. 709/206

(57) ABSTRACT

Apparatus and a method of obtaining revenue for Short Message Service (SMS) messages for a destination network of an SMS message. The destination network checks whether an SMS message is spam (unwanted content). If so, the destination network checks whether the source network as identified in the SMS message is consistent with the identity of the domain of the source of the message and the sender is either chargeable or from a trusted network. If both tests pass, the sender is charged for the spam message. If the message is then delivered to the destination, the destination network collects a portion of the revenue received by the source network. If the message is not delivered, then, optionally, the destination network can charge the source network for the spam filtering costs. For detected spam messages, a spam warning message is sent to the source (i.e., the spammer). Advantageously, the destination network receives compensation for processing spam messages, and the spammer is warned.

### TECHNICAL FIELD

This invention relates to a method and apparatus for deriving revenue from recognized unwanted short message service messages (spam) when service providers verify the spam senders are chargeable.

### BACKGROUND OF THE INVENTION

A major problem of the current short message service (SMS) is the prevalence of unwanted messages (spam). As the problem has become more severe, better spam filters have been incorporated into SMS networks. Of course, at the same time, the sources of spam, “spammers”, have become more sophisticated in finding techniques for designing messages that penetrate such filters. Different customers have shown different levels of tolerance for different kinds of spam so that even some messages which are recognized as being spam are delivered to the destination customers.

Many spam messages traverse two telecommunications carriers—an originating carrier connected to the source of the message and a terminating carrier connected to the destination of the message. Revenue is shared between the carriers in accordance with an agreement. If the originating carrier detects a spam message and does not forward the message, the originating carrier receives all revenue only from the source of the message. In accordance with most agreements, if the originating carrier forwards the message to the terminating carrier, whether or not it has detected that the message is spam, the terminating carrier will receive a portion of the charges charged by the originating carrier provided that the terminating carrier sends the message to the destination.

One of the problems with many spam messages is that the spammer inserts a source address different from the spammer's actual address. The originating network can still charge the spammer because the originating network does not use the source address in the message to determine the source, but the terminating carrier cannot claim a portion of the originating network charges, if it cannot identify the originating network, which is frequently the case.

In general, a problem of the prior art is that the telecommunications carriers who are forced to handle these spam messages are sometimes getting insufficient revenue for their efforts. This is true for those cases in which the spammer prefaces the message with a false sender identification indicating a false sender network (spoofing). For example, if the terminating carrier transmits the message to the destination, and then seeks payment of a portion of the originating network charges, if the terminating network cannot identify the originating network, the terminating network cannot share revenue collected by the originating network. If the originating network is not “trusted”, i.e., trusted to provide a fair share of the revenue for the call, the destination network will not deliver a spam message, but receives no revenue for handling the uncompleted call.

### SUMMARY OF THE INVENTION

The above problem is alleviated and an advance is made over the teachings of the prior art in accordance with this invention wherein spam messages which are delivered to their destination are fully charged to the calling party by the telecommunications carrier(s) transmitting the messages provided that the caller and originating network are “trusted” (i.e., considered capable of paying for the call); the terminating network collects a portion of revenues from the originating network when the spam message is delivered in the terminating network; the originating network will charge the sender for originating the message; the terminating network will claim a portion of revenues from the originating network who collected from the sender based on the agreement between two networks for messages which cross the boundary between two telecommunications carriers, for message delivered to the terminating receiver; for messages which have an originating address that does not match the domain of the source of the message (spoofing) and for which the carrier in whose domain the originating address is found will not be able to charge the calling customer, the terminating network does not deliver the message. Accordingly, the terminating network will only deliver messages if it can receive a portion of the originating network charges.

In accordance with one feature of Applicant's invention, for spam messages intercepted at the destination network, the destination network is optionally reimbursed for a portion of the originating network charges even if the spam message is not delivered in accordance with a revised agreement. Advantageously, the network which performs the spam filtering is reimbursed for this function. Advantageously, spam messages are fully charged to the spammer and the spammer's network.

In accordance with one feature of Applicant's invention, for detected spam messages, the terminating network returns a message to the caller warning the caller that the message was found to be spam. Advantageously, the spammer is warned.

### BRIEF DESCRIPTION OF THE DRAWINGS

FIG. 1 is a block diagram illustrating the operation of Applicant's invention; and

FIG. 2 is a flow diagram illustrating the method of Applicant's invention.

### DETAILED DESCRIPTION

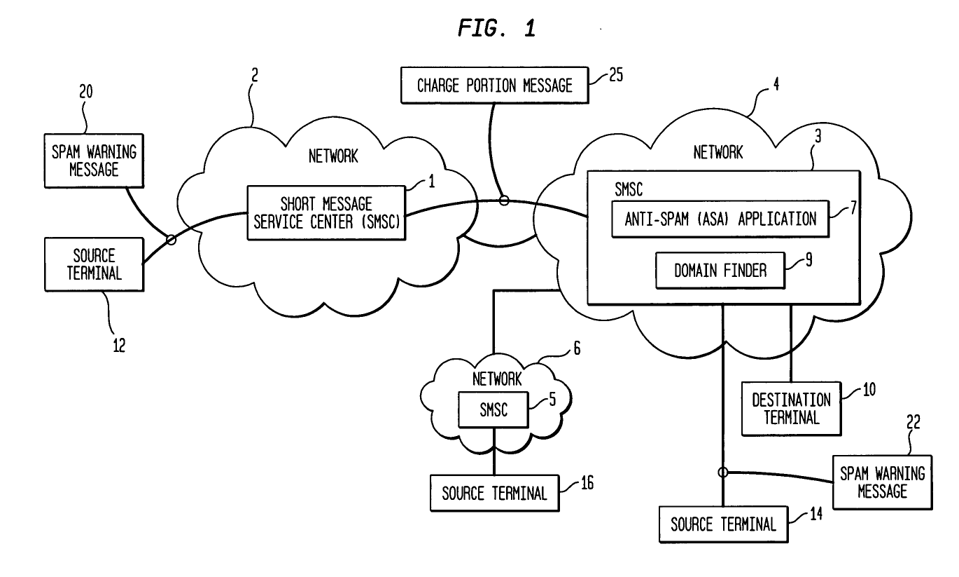

FIG. 1 is a block diagram illustrating the operation of Applicant's invention. For the case of greatest concern, a source terminal 12 in a network 2 sends an SMS message to destination terminal 10 served by network 4. If the message is not a spam message then network 2 is entitled to the revenue for an originating message. In addition, network 4 upon completing the transmission of the message to the destination terminal requests from network 2 a portion of the revenue collected by the network 2 from terminal 12, because under the prevalent present arrangements, the terminating network is entitled to a portion of the revenues generated in the source network if the message is delivered.

The destination network 4 includes in its SMS Center (SMSC) 3, an anti-spam application (ASA) 7 which checks whether the message received from source terminal 12 is a spam message. If the anti-spam application (ASA) 7 finds that the message is a spam message and the destination terminal 10 is willing to accept spam messages, or at least the category of spam messages which the ASA has found for this message, the SMSC 3 or ASA 7 will determine whether the source terminal 12 or source network 2 is trusted. If trusted and chargeable, the SMSC will deliver the message to the destination terminal 10; SMSC 3 then causes a spam warning message 20 to be sent to the source terminal 12. If the destination network finds that the message comprises undeliverable spam, the destination network may, in accordance with one feature of Applicant's invention, request payment from the source network.

FIG. 1 also illustrates the case in which a spammer at source terminal 16 in network 6 sends a message including a source address in the domain served by network 2. (This process is called “spoofing”.) The SMSC 5 which serves source terminal 16 will charge source terminal 16 for transmitting the message. Spammer source terminal 16 spoofs the message as sending from the network 2. The message appears to have a sender from terminal 12 in network 2. ASA 7 in network 4 has a domain finder 9 which will check the sender address (terminal 12 in the network 2) received in the message against the domain of the network 6 which transmitted the message. In this case, there is a mismatch so that destination network 4 knows that the sender is spoofing and that apparent source network 2 should not be asked to provide a portion of the revenues for the call. The message is discarded by destination network 4.

Source terminal 14 is in the same network 4 as destination terminal 10. In that case, there is no need to share a portion of the terminating charges with the originating network since the originating and terminating networks are the same. The message from source terminal 14 is checked by the anti-spam application 7 to see if it is a spam message; if so and terminal 14 is chargeable, if the message is completed and terminal 14 is charged for sending the message; a spam warning message 22 is sent to the source terminal 14.

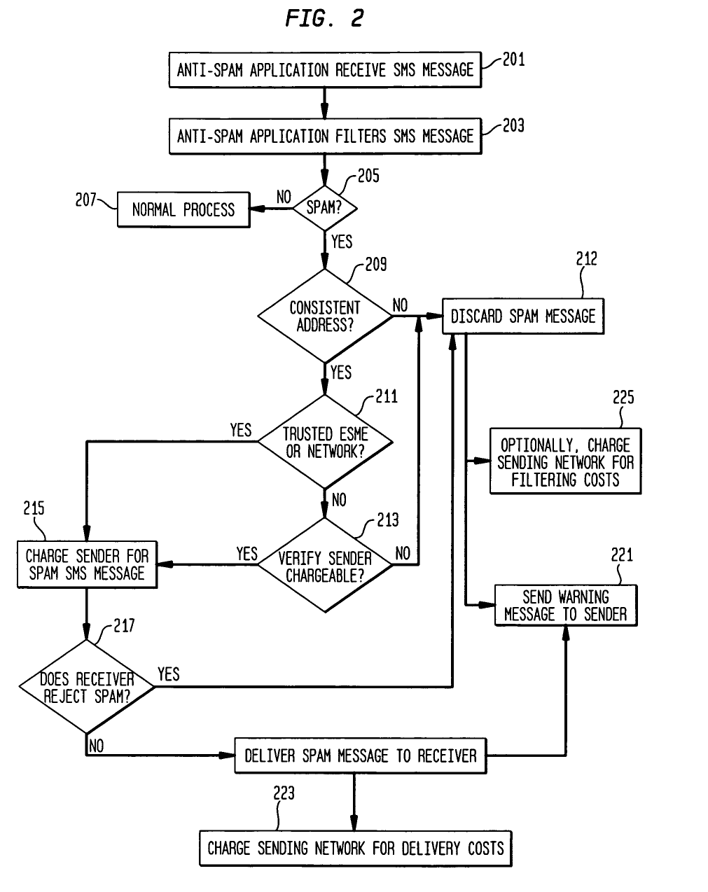

FIG. 2 is a flow diagram illustrating the method of Applicant's invention. An anti-spam application (ASA) receives an SMS message (action block 201). The ASA filters the SMS message (action block 203). Test 205 determines whether the filtering action detected a spam message. Any spoofed message is treated as if it contains spam. If not, the SMS message is subject to normal processing (action block 207). If a spam message has been detected in test 205, then test 209 determines whether the address in the message is consistent with addresses from the domain from which the message was received. If the addresses are inconsistent then the message is discarded (action block 212) but the true source network independently charges the source customer. If the address is consistent then test 211, controlled by ASA 7, determines whether the source is a trusted network, or, equivalently an external short message entity (ESME) which is trusted by the source network for sending SMS messages. The object of test 211 is to help determine whether the destination network can expect to collect revenue shared from the originating network for this call. If the source is not a trusted ESME or a trusted network, then test 213, controlled by ASA 7, determines whether the sender is chargeable. If the result of test 213 is a determination that the sender is not chargeable then the spam message is discarded (action block 212). If test 213 determines that the sender is chargeable or if the result of test 211 was positive, then the sender is charged for transmission of the spam SMS message. Then test 217 made in the terminating network determines whether the receiver has a class of service for rejecting spam messages. If so, the spam message is discarded. Then, optionally, the destination network can request reimbursement from the source network for spam filtering costs. If the receiver will accept spam messages, then the spam message is delivered (action block 219) and a warning message is sent to the sender (action block 221). The source network is charged by the destination network for delivery costs. The warning message is also sent in all the cases where the spam message is discarded, i.e., following action block 212.

The above description is of one preferred embodiment of Applicant's invention. Other embodiments will be apparent to those of ordinary skill in the art. The invention is limited only by the attached claims.

I claim:

1. In a system for transmitting short message service (SMS) messages from a source terminal served by a source network to a destination terminal served by a destination network, a method of charging for spam messages comprising the steps of:
determining in said destination network that a message is spam;
determining that the message is headed by an address which is consistent with a domain of the source of said message;
if the result of both determinations is positive, in said destination network, charging a source network of said message for sending the message to said destination network.

2. The method of claim 1 further comprising the steps of:
determining whether a destination terminal of said message accepts spam messages; and
if not, charging said source network even though said message is not delivered to said destination terminal.

3. The method of claim 1 further comprising the steps of:
determining whether said source network or source terminal is trusted; and
if said source network or terminal is not trusted, verifying whether said source terminal is chargeable;
if said source terminal is not chargeable, discarding the spam message;
if said source terminal is chargeable, charging said source terminal for sending said spam message.

4. The method of claim 3 further comprising the steps of:
if said spam message is not discarded, testing whether said destination terminal rejects detected spam messages;
if said destination terminal rejects detected spam messages, discarding said spam message;
if said destination terminal accepts spam messages, delivering said spam message and charging said source network for delivery of said spam message.

5. The method of claim 1 further comprising the step of:
sending a spam warning message to said source terminal.

6. In a system for transmitting short message service (SMS) messages from a source terminal served by a source network to a destination terminal served by a destination network, apparatus for charging for spam messages comprising:
means for determining in said destination network that a message is spam;
means for determining that the message is headed by an address which is consistent with a domain of the source of said message;
means, responsive to both determinations being positive, in said destination network, charging a source network of said message for sending the message to said destination network.

7. The apparatus of claim 6 further comprising:
means for determining whether a destination terminal of said message accepts spam messages; and
means, responsive to determining that said destination terminal does not accept spam messages, for charging said source network even though said message is not delivered to said destination terminal.

8. The apparatus of claim 6 further comprising:
means for determining whether said source network or source terminal is trusted; and
if said source network or terminal is not trusted, means for verifying whether said source terminal is chargeable;
if said source terminal is not chargeable, means for discarding the spam message;
if said source is chargeable, means for charging said source terminal for sending said spam message.

9. The apparatus of claim 8 further comprising:
if said spam message is not discarded, means for testing whether said destination terminal rejects detected spam messages;
if said destination terminal rejects detected spam messages, means for discarding said spam message;
if said destination terminal accepts spam messages, means for delivering said spam message and charging said source network for delivery of said spam message.

10. The apparatus of claim 6 further comprising:
means for sending a spam warning message to said source terminal.
